(19) United States
(12) Patent Application Publication
(10) Pub. No.: US 2006/0180284 A1
(43) Pub. Date: Aug. 17, 2006

(54) Child safety gate

(76) Inventor: Katherine Wiggins, Bristol, IL (US)

Correspondence Address: MERONI + MERONI, P.O. BOX 309, BARRINGTON, IL, 60011, US

(21) Appl. No.: 11/058,350

(22) Filed: Feb. 15, 2005

(51) Int. Cl. E06B 9/00

(52) U.S. Cl. 160/368.1

(57) ABSTRACT

The child safety gate comprises a rigid frame structure including a pair of transversely spaced rigid upright frame legs and an intermediate leg positioned at right angles to the upright frame legs, a flexible gate member having means securing the gate member in unitary assembly with the rigid frame structure; and a pair of flexible strap-like adjustable hinges secured to the transversely spaced rigid upright frame legs for securing the flexible adjustable foldable hinges to stairway posts. Each of the flexible adjustable hinges is comprised of a flexible top strip piece having a cushioned non-slip fabric layer secured on an inside surface and each of the strip pieces and the cushioned non-slip fabric layer are sized, shaped and positioned for assembled contact with upright stairway posts to present slipping of the straps thereby keeping the gate firmly position and to avoid scratching of the upright stairway posts when attached to the upright stairway posts. The flexible adjustable hinges each have releasable fastener means for attaching the three sided rigid frame structure to any shape and size-stairway posts in assembled relation.

### BACKGROUND OF THE INVENTION

1. Field of the Invention

The present invention relates to a safety gate for small children comprised of synthetic plastic with a pair of zippers optionally provided for providing closed and opened ingress and egress, the gate having a rigid frame structure, a pair of transversely spaced upright frame legs, an intermediate leg, a flexible gate member and a pair of non-metallic strap-like flexible adjustable hinges with upright frame legs containing adjustable foldable hinges for securement to stairway posts to avoid disfiguring or scarring of exterior surfaces of the stairway posts.

2. Description of the Prior Art

Heretofore various child safety gates have been proposed which in some form or another utilize the theory of attaching the gate to a bannister or stairway post for ingress and egress to safely restrain and protect infants, toddlers and even pets. Further, metallic fasteners, screws and hinges have been used which disfigure and mar exterior surfaces of wooden bannisters and stairway posts. Additionally, such screws and fasteners can not be used on metal bannister posts and are difficult, if not impossible, to use on certain shapes and sizes of bannister posts.

It will be understood that there are different types of safety gates that have been used in the past, but none of them have been designed for homes as have been built in recent times with beautiful stairways linking upper floors and lower floors. These stairways are often built from expensive woods and are works of art in and of themselves. Most new homes (including starter townhomes) (in all price categories) have the stairs with two upright banister end posts. In the past, some homes had an end post on one side of the stair opening and a wall (with a handrail) on the other side. My invention works on any stair with a pair of end posts. Accordingly, home owners having such stairways with a pair of bannister posts are reluctant to install child safety gates of the type that have existed in the past for the ones that have been used require hinges, screws and metal components which tend to mar the beautiful woodwork that has been used in the fanciful stairways in the homes of this day and age.

What is needed, therefore, is a more efficient, inexpensive, adjustable safety child gate that can be installed for the purposes of better controlling infants, young children and pets in their movements between the floors using the fanciful wooden stairways and/or any stairway with a pair of upright bannister end posts (including metal, etc.). To this end, it is the important object of this invention to solve this pre-existing problem and to enable a homeowner to preserve stairways in a more pristine condition so that the beauty of the stairway can remain unmarred. Additionally, the adjustable strap feature allows all different shapes and sizes of bannister end posts to be attached to easily and without incident. No adapters or attachments are needed regardless of style, shape, size or material of end posts. Also, the adjustable straps themselves afford a certain degree of flexibility in regards to the overall width of the gate and therefore the width of the stair opening to be gated.

Examples of prior existing U.S. patents are listed below:

| U.S. Pat. No. | Title | Patentee |
|---|---|---|
| 4,787,174 | Child Safety Gate | Brown |
| 5,360,191 | Bannister Attachment Especially | Carson, et al. |
| | Adapted For Facilitating The | |
| | Mounting Of A Child Safety Gate | |
| 5,457,914 | Safety Gate For Juveniles With | Johnson, Jr. |
| | Security Brackets | |
| 5,531,258 | Folding Soft Gate | Poulson, et al. |
| 5,657,809 | Security Gate | Longoria, et al. |
| 5,906,068 | Adjustable Child Safety Gate | Bode |
| 6,370,823 | Child Safety Barrier | Andersen |
| 6,375,165 | Movable Barrier For Infants | Sherratt, et al. |

U.S. Pat. No. 5,360,191 issued to Carson discloses a bannister attachment especially adapted for facilitating the mounting of a child safety gate. Top and bottom box frame members secured to the elongated body member are selectively mountable around the end post of a banister of a stairway to semi-permanently secure the bannister attachment at the head of a stairway.

U.S. Pat. No. 5,531,258 issued to Poulson discloses a security gate for positioning within an area way such as a doorway. The gate includes a support structure defined by a frame and a flexible panel supported by the frame. The frame includes horizontal members and vertical members wherein the vertical members may be conveniently folded to a position parallel to the horizontal members whereby the gate is folded to a compact configuration for transportation or storage.

U.S. Pat. No. 6,375,165 issued to Sherratt discloses a moveable gate for infants used in doorways to provide a safe barrier. The gate is formed of a flexible material which pulls out of a housing in the manner of a window shade. A jamb mounting at the housing end and a latch at the extended end of the curtain-like barrier mounts the moveable gate. Important features are the manner in which the gate latches, a mechanism for tightening the curtain-like barrier, and childproof devices for releasing tension in the gate when it is to be retracted.

U.S. Pat. No. 6,470,948 issued to Yates discloses a collapsible child safety gate for forming a barrier across an opening inside a house such as a stairway that includes a storage housing capable of being fixed in position across the house opening either permanently or temporarily. A folding curtain can be stored in the housing when folded and can be withdrawn therefrom along guide tracks to an extended position for forming a barrier across an opening.

### SUMMARY OF THE INVENTION

According to the present invention, there is provided a child safety gate comprising a rigid frame structure including a pair of transversely spaced rigid upright frame legs and an intermediate leg positioned at right angles to the upright frame legs. There is a flexible gate member having means to secure the gate member in unitary assembly with the rigid frame structure. The child safety gate also has pairs of flexible adjustable hinges with each pair secured to a different one of the transversely spaced rigid upright frame legs for securing the flexible adjustable foldable hinges to spaced apart stairway posts. Each of the flexible adjustable hinges is comprised of a flexible top strip piece having a soft fabric layer secured on an inside surface with each of the strip pieces and the cushioned non-slip material fabric layer being sized, shaped and positioned for assembled contact with upright stairway posts to prevent slipping of the stair, scarring and/or scratching of the upright stairway posts when attached to the upright stairway posts. The flexible adjustable hinges each have releasable fastener means for attaching the three sided rigid frame structure to stairway posts in assembled relation.

Further, according to important features of my invention, I have provided a rigid frame comprised of three wooden dowels or legs disposed in U-shaped relation and connected to the flexible gate member with the rigid frame made of synthetic plastic with the frame legs and the intermediate frame leg being joined in one piece together.

In addition, according to further features of my invention, the rigid frame has a pair of tubular L-shaped corner members with opposite hollow ends being hollow, the frame legs comprising dowels being telescopingly engaged in the opposite hollow ends of the L-shaped corner members, and fasteners holding the frame legs or dowels in secured attachment with the L-shaped corner members all in unitary rigid relation.

Yet another feature relates to my child safety gate being comprised of a pair of transversely spaced zippers which extend from an upper edge of the flexible gate member to the intermediate frame leg and are secured to the flexible gate member, the zippers coacting with the flexible gate member when in a closed position serving to prevent ingress and egress through the flexible member and when in an open position allowing an intermediate gate section to drop to a lower level in close adjacency to the intermediate frame leg thus permitting ingress and egress through a gate opening created when the intermediate gate section has dropped as a result of the zippers being unzipped.

Still another feature of my invention is a flexible gate member comprising a rigid gate frame structure including a pair of transversely spaced rigid frame legs and an intermediate frame leg positioned at right angles to the transversely spaced rigid upright frame legs, a flexible gate member having means securing the gate member in unitary assembly with the rigid frame structure, and pairs of flexible strap-like adjustable hinges with each pair secured to a different one of the transversely spaced rigid upright frame legs for securing the flexible adjustable foldable hinges to said spaced apart stairway posts, each of the flexible adjustable hinges being comprised of a flexible top strip piece having a cushioned non-slip fabric layer secured on an inside surface for confronting engagement with one of the stairway posts, each of the strip pieces and the cushioned non-slip fabric layer being sized, shaped and positioned for assembled contact with the upright stair posts to prevent disfiguring, slipping of the strap, scratching and scarring of the exterior surfaces of the upright stairway posts when attached to the upright stairway posts.

Another feature of my invention relates to a modification wherein the intermediate frame leg comprises a connecting rod structure, the connecting rod structure having spring loaded finger-like pin members, push buttons for releasing said finger-like pin members to move the spring loaded finger-like pin members from a storage position to an upright position, and pin sockets at bottom ends of the transversely spaced rigid upright frame legs with the pin sockets being shaped and configured to receive the spring loaded finger-like pin members for securing the connecting rod structure to the transversely spaced rigid upright frame legs.

### BRIEF DESCRIPTION OF THE DRAWINGS

FIG. 1 is a fragmentary perspective view of my improved child safety gate mounted to stairway posts.

FIG. 2 is an enlarged exploded view of the child safety gate shown in FIG. 1 with an intermediate section of a flexible gate member shown in full and dotted lines to illustrate how the flexible gate member can be opened and closed for ingress and egress.

FIG. 3 is an enlarged fragmentary perspective view of the gate shown in FIG. 2 with the gate components shown in assembly together only with a modified zipper arrangement.

FIG. 4 is an enlarged fragmentary sectional view taken essentially on the lines 4-4 as illustrated in FIG. 2 illustrating the manner of assembly of dowels with L-shaped corner members and with spring locking pins shown in exploded relation.

FIG. 5 is a plan view of one of a pair of flexible adjustable straps which function as post-gate hinges.

FIG. 6 is a bottom plan of the flexible adjustable strap shown in FIG. 5.

FIG. 7 is a diagrammatic view in full and dotted lines illustrating the way in which the flexible gate member (zippers omitted) can be folded for shipment and/or storage.

FIG. 8 is an enlarged fragmentary view of the flexible gate shown in a collapsed state for storage and/or shipment.

FIG. 9 is a modified side view of my flexible gate member shown in FIG. 3 only with a one piece rigid frame.

FIG. 10 is an enlarged side view of the modified one piece rigid frame structure shown in FIG. 9.

FIG. 11 is a bottom edge pipe with the side pipes pulled up ready to slide down onto the bottom edge pipes' two upright ends.

FIG. 12 is an enlarged view of the lower left connection taken from FIG. 11 as shown at 12 in FIG. 11.

FIG. 13 shows the method of threading a horizontally extending pipe through a lower horizontally extending tunnel in the gate material.

FIG. 14 shows the pipe of FIG. 13 secured with one of the upright legs for packaging similar to that shown in FIGS. 7 and 8 but with these components in assembled relation.

### DESCRIPTION OF THE PREFERRED EMBODIMENT(S)

Most new homes have the pair of upright posts where in the past it may have been one post and a wall with a hand rail. A child safety gate 6 is provided for mounting upon a such configured wooden stairway 8 such as can be found in a majority of new homes today which have a pair of wooden finely finished upright stairway posts 10-10. The stairway safety gate 6 is sized to fit in an upright position between the posts when in assembled relation therewith. The safety gate safely restrains, protects and prevents passage of small children, such as infants and toddlers. The child safety gate 6 is made of synthetic plastic comprising a three-sided rigid frame structure 12 comprised of three wooden dowels 14 (FIG. 2) disposed in U-shaped relation. The three wooden dowels 14 provide three frame legs including, a pair of transversely spaced rigid upright frame legs 16-16 and an intermediate frame leg 18 positioned at right angles to said upright frame legs 16-16. The child safety gate 6 also has a flexible gate member 20 with fastener means indicated generally at 22 to secure the gate member 18 in unitary assembly with the rigid frame structure 12.

This fastener means 22 comprises two pairs of flexible strap-like adjustable straps or hinges 24-24 which are secured to the transversely spaced rigid upright frame legs 16-16. These pairs of straps or hinges 24-24 secure the flexible gate member 20 to the stairway posts 10-10.

The flexible gate member 20 is provided with tubular sleeves 25 for receiving the three wooden dowels 14. These tubular sleeves can be either manufactured or molded in one piece as part of the synthetic plastic gate member or if a canvas fabric is used, then the sleeves 25 can be formed by stitching portions of the edges of the fabric in lapped engagement with one side of the gate member 20 to form tubular sleeves to receive the dowels 14.

It will be seen from FIG. 2 that the dowels 14 are sized and shaped to set into the sleeves 25 in telescoped relation when in assembly together.

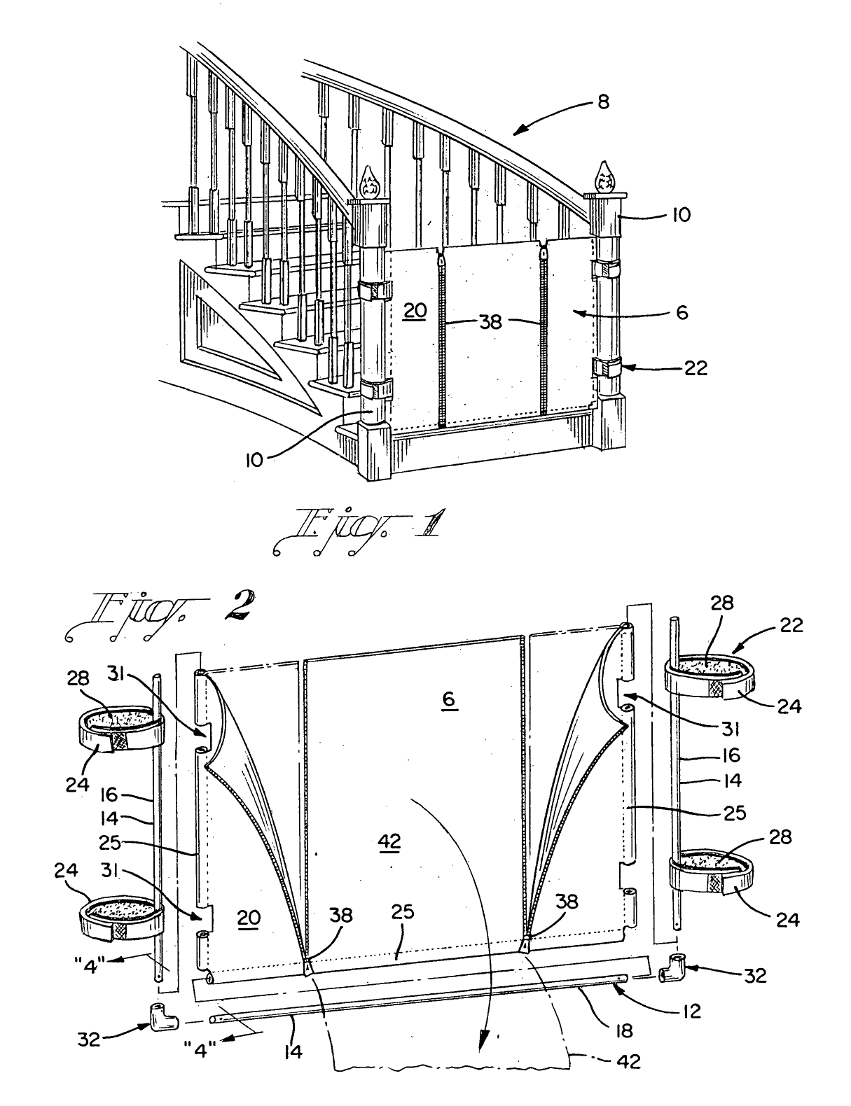

This invention also contemplates the use of a one piece plastic U-shaped member 42, as shown in FIG. 10, instead of individual dowels for assembly in the sleeves 25 which is a modification of the embodiment shown in FIG. 1.

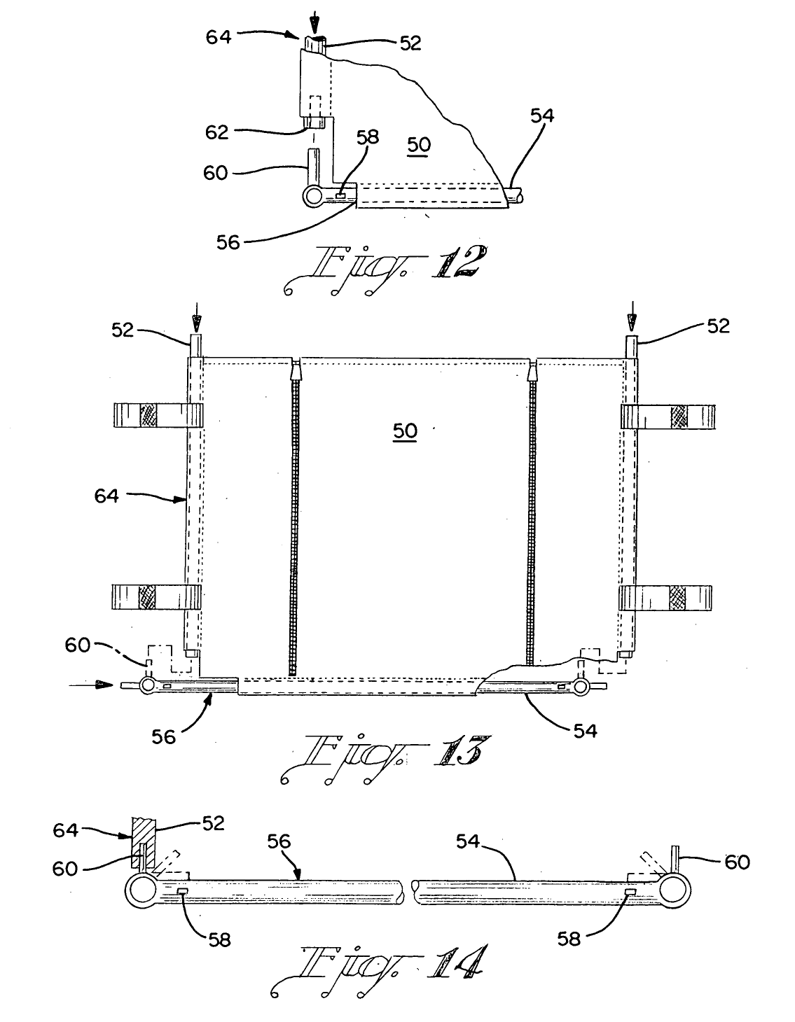

A further modification of the support structure for the flexible gate member 20 is shown in FIGS. 11-14, which will be discussed further at a later point herein.

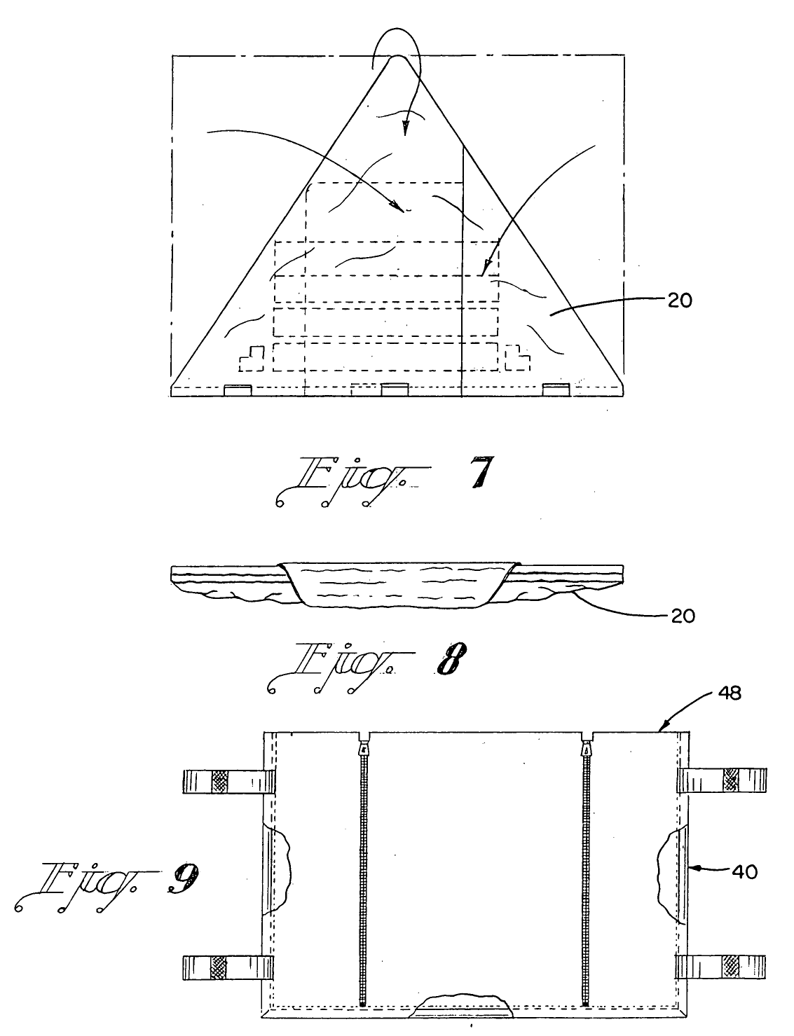

The pairs of flexible adjustable foldable hinges 24-24 (FIGS. 5 and 6) are each comprised of a flexible top strip piece 26 which has a cushioned non-slip fabric layer 28 being sized, shaped and positioned for assembled contact with the wooden upright stairway posts 10-10 to prevent any scratching, slipping of the strap, scarring or disfiguring of the wooden upright stairway posts 10-10. Each of the flexible adjustable hinges 22 each have a releasable fastener means 30 for attaching the three-sided rigid frame structure 12 to the stairway posts 10-10 in assembled relation. The releasable fastener means 30 can comprise fasteners of different types. I have found that the hook and loop type of fastener, otherwise known as a Velcro type fastener, is very usable for my purposes in the practice of my invention. Other types of fasteners may be used, such as snap type fasteners. Also, hook and eye type fasteners could be used.

The cushioned non-slip fabric layer 28 can be comprised of a cushioned non-slip material or a synthetic plastic equivalent.

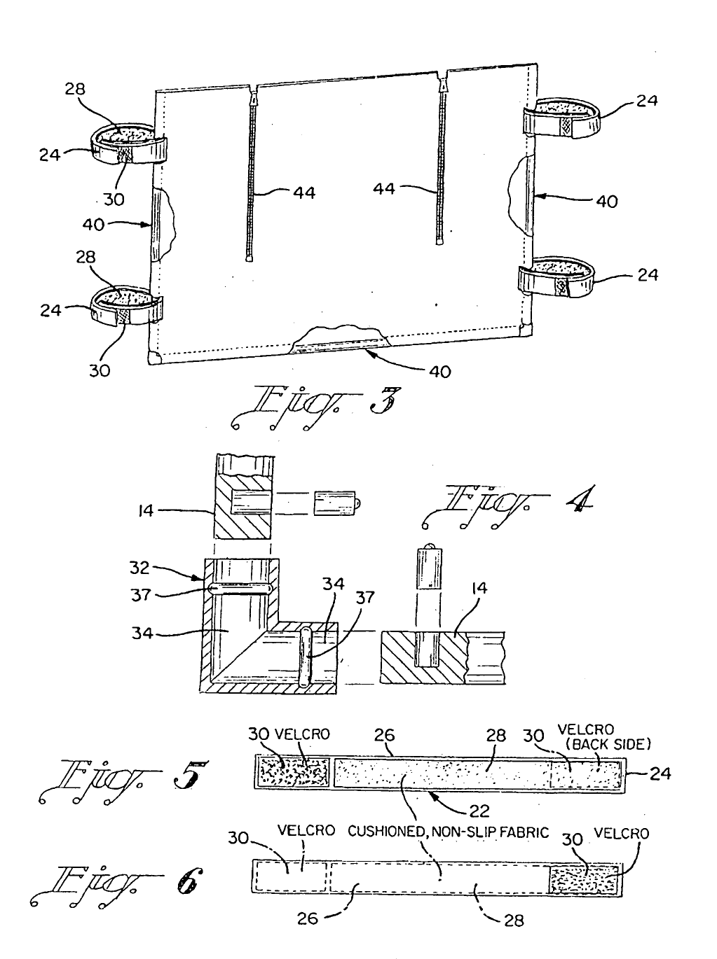

The strips or hinges 24-24 are also provided with releasable fastener means 30-30 which may comprise hook and loop type fasteners located on opposite sides of the fleece strip piece 26. It will be seen from an examination of FIG. 3 how the hook and loop fasteners are positioned relative to the cushioned non-slip fabric layer 28 which is connected on the inside strip so as to be engageable against the exterior of the stairway posts 10-10.

While I have illustrated my preferred type of fastener, it being the hook and loop fastener, it should be understood that other types of fasteners can be added without departing from my invention. As an example, one further type of fastener would be to buy snaps which are commonly used in the manufacture of garments in place of the hook and loop fastener or hook and eye fastener in which event the strip may need to be elasticized so that the hinge member could be properly secured according to the user's needs.

It will be further seen that the tubular sleeves 25 on the gate member 20 are slotted at two places on each side of the gate member 20 as indicated at 31. These gate slots 31 have a width slightly greater than the width of the flexible adjustable hinges 24-24 so that the folded hinge member 24 will be lodged in the slots 31 and held in the slots 31 by the dowels 14 on both sides of the gate member 20. In this way, the gate member 20 can be quickly assembled should it be shipped to the customer in a knock-down form. To attain this end, the dowels 14 can be put in place and the flexible adjustable hinges 24 can be inserted in the slots 31 either before or after the dowels 14 are put in place in the tubular sleeves 25.

In order to hold the dowels 14 rigidly in place, I have provided a pair of tubular L-shaped corner members 32 which are intended to be assembled with the rigid frame structure 12, as shown in exploded relation in FIG. 2, and with the details of the L-shaped corner members 32 being further illustrated in FIG. 4.

In FIG. 4 it will be seen that these L-shaped corner members 32 are provided with opposite hollow ends 34 which are hollow so that the frame legs 16-16 can be telescopingly engaged in the opposite hollow ends 34 and having cylindrical pin type fasteners 36 mounted in lower ends of the frame legs 16-16 in engaged attachment with the L-shaped corner members 32. The cylindrical pin type fasteners have spring loaded balls 37 (FIG. 4) for snap-in, snap-out engagement with ring grooves in the hollow ends 34 of the corner members 32.

In order to make the child safety gate 6 more functional and installed in place as shown in FIG. 1 and to allow ingress and egress, I have provided the gate 6 with a pair of transversely spaced zippers 38-38 which extend from an upper edge of the flexible gate member 20 to the intermediate frame leg 18 and are secured to the flexible gate member 20. The zippers 38-38 coact with the flexible gate member 20 when in a closed position serving to prevent ingress and egress through the flexible gate member 20 and when unzipped then creating an open position, thus then allowing an intermediate gate section 42 of said flexible gate member 20 to drop to a lower level in close adjacency to the intermediate frame leg 18 thus permitting ingress and egress through a gate opening created when the intermediate gate section 42 has dropped after the zippers 38-38 have been unzipped.

The flexible gate member 20 is shown in different positions in FIGS. 1 and 2 with the zippers 38-38 being shown in a closed position in FIG. 1 and in an open position in FIG. 2.

In FIG. 2 it will be seen that the intermediate gate section 42 is shown in a collapsed position to allow ingress and egress through the date member 20 when desired. Normally, it is intended that the gate member 20 and the zippers 38-38 will be in a so-called closed position when it is desired to control movement through the gate 6 by a dog, person, infant, or whatever.

In FIG. 3, I have shown a modified so-called zipper arrangement where smaller zippers 44 are used on a flexible gate member 46. In this instance, the zippers 44 can only be opened in a more limited way rather than have the zippers 44 extend to the bottom of the flexible gate member 20, as shown in FIG. 2.

To enable the gate 6 to be readily shipped to a customer, it will be seen from a consideration of FIG. 7 that the corners of the flexible gate member 20 can be folded in the direction indicated by the arrows and then rolled up, as illustrated in FIG. 8, into a compact folded arrangement.

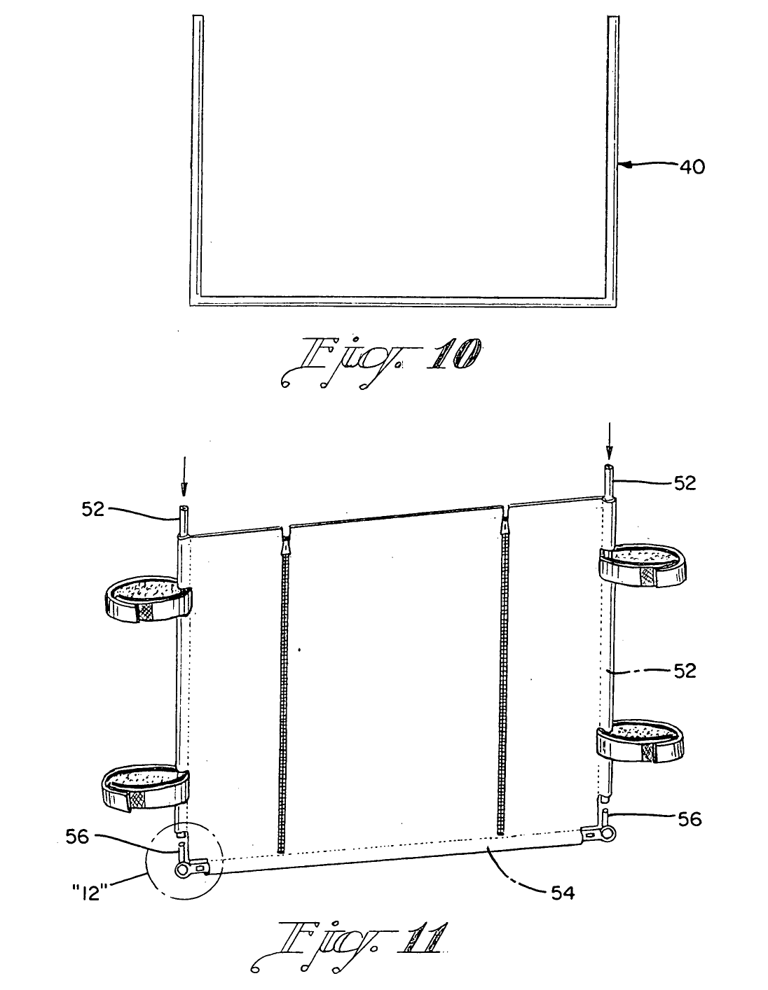

In FIG. 9, a further modified child safety gate 48 is illustrated. This gate 48 is similar to the one shown in FIG. 3 with hinges 49 being similar to those being shown in FIG. 2. In this instance, the modified gate 48 has a one piece U-shaped plastic member 40, as further shown in FIG. 10. It will thus be seen that two different forms of supports have been utilized for rigidifying the flexible gate member 20 (FIG. 1 or the modified gate 48 in FIG. 9) at its perimeter leaving a top edge of the flexible gate member 20 unsupported except by the strength of the material itself which is used to manufacture the flexible gate member 20, assuming that synthetic plastic material is the material that is chosen to be used.

It is also contemplated that some type of woven cloth or woven fabric might be used, if desired.

The rigid frame structure 12 further has a pair of tubular L-shaped corner members 32 with opposite hollow ends 34 being hollow and the frame legs 16-16 being telescopingly engaged in the opposite hollow ends 34 and having fasteners 36 to hold the frame legs 16-16 in engaged attachment with the L-shaped corner members 32 in unitary rigid relation.

In addition, the child safety gate 6 has a pair of transversely spaced zippers 38-38 which extend from an upper edge of the flexible gate member 20 to the intermediate frame leg 18 and are secured to the flexible gate member 20, and the zippers 38-38 coact with the flexible gate member 20 when in a closed position serving to prevent ingress and egress through the flexible gate member 20 and when unzipped then creating an open position thus then allowing an intermediate gate section of said flexible gate member 20 to drop to a lower level in close adjacency to the intermediate frame leg 18 thus permitting ingress and egress through a gate opening created when the intermediate gate section has dropped after the zippers have been unzipped.

Turning now to FIGS. 11-14, it will be here seen that still a third type of support system is provided for my flexible gate member 50 which is similar to the flexible gate member 20. The flexible gate member 50 has a pair of upright rigid tubular legs 52-52 and an intermediate rigid connecting leg 54. In this instance, the intermediate rigid connecting leg 54 in reality comprises a form of a connecting rod structure 56. The connecting rod structure 56 is shown out of position in FIG. 13 for illustrative purposes. The dotted line illustrations show how the connecting rod can be positioned as it is moved in the direction indicated by the arrow at the bottom of the left side of FIG. 13. The connecting rod structure 56 also has push buttons 58-58 which enables a spring loaded finger-like pin member 60-60 at each end of the connecting rod structure 56-56 with each member 60-60 being rotatable on its ball shaped end on a synthetic plastic socket to be moved from a storage position as shown by the dotted lines in FIG. 14 to an upright position at right angles to the rigid leg 54 otherwise identified as the connecting structure rod 56. These upright pins 60-60 are adapted to be engaged in pin sockets 62 provided in lower ends of the upright rigid legs 52-52 to hold the rigid frame structure 64 in assembly with the flexible gate member 50.

It should be understood that the child safety gate shown in FIG. 14 illustrates my preferred embodiment.

The leg 54 is diagrammatically shown and indicated by dotted lines in FIG. 11. The upright legs 52 are tubular in configuration and can be of a synthetic plastic composition or metallic composition, if desired. The legs 52-52 and 54 are all adapted to be installed in virtually the same way as previously described.

The modification shown in FIG. 14 also allows for easier shipping and storage of the gate when in a collapsed position.

The above described preferred embodiments are intended to illustrate the principles of the invention, but not to limit its scope. Other embodiments and variations to this preferred embodiment will be apparent to those skilled in the art and may be made without departing from the spirit and scope of the invention, as defined in the following claims.

I claim:

1. A child safety gate comprising:
a rigid frame structure including:
a pair of transversely spaced rigid upright frame legs and an intermediate frame leg positioned at right angles to said transversely spaced rigid upright frame legs;
a flexible gate member having means securing the gate member in unitary assembly with said rigid frame structure; and
pairs of flexible strap-like adjustable hinges with each pair secured to a different one of the transversely spaced rigid upright frame legs for securing the flexible adjustable foldable hinges to spaced apart stairway posts, each of the flexible adjustable hinges being comprised of a flexible top strip piece having a cushioned non-slip fabric layer secured on an inside surface for confronting engagement with a stairway post, each of the strip pieces and said cushioned non-slip fabric layer being sized, shaped and positioned for assembled contact with upright stairway posts to prevent disfiguring, scratching and scarring, of exterior surfaces of the upright stairway posts when attached to the upright stairway posts and to prevent slipping of the strap thereby keeping the gate firmly positioned, the flexible adjustable hinges each having releasable fastener means for attaching the three sided rigid frame structure to stairway posts in assembled relation.

2. The child safety gate of claim 1 where the rigid frame is comprised of synthetic plastic with the frame legs and the intermediate frame leg being joined in one piece together.

3. The child safety gate of claim 1 where the rigid frame is comprised of three wooden dowels disposed in U-shaped relation and connected by said means to said flexible gate member.

4. The child safety gate of claim 1 where the rigid frame has a pair of tubular L-shaped corner members with opposite hollow ends being hollow, the frame legs being telescopingly engaged in the opposite hollow ends, and fasteners holding the frame legs in engaged attachment with said L-shaped corner members in unitary rigid relation.

5. The child safety gate of claim 1 comprising a pair of transversely spaced zippers extending from an upper edge of the flexible gate member to said intermediate frame leg and secured to the flexible gate member, the zippers coacting with said flexible gate member when in a closed position serving to prevent ingress and egress through the flexible member and when in an open position allowing an intermediate gate section to drop to a lower level in close adjacency to said intermediate frame leg thus permitting ingress and egress through a gate opening created when the intermediate gate section has dropped.

6. The child safety gate of claim 3 where the rigid frame has a pair of tubular L-shaped corner members with opposite hollow ends being hollow, the frame legs comprising said dowels being telescopingly engaged in the opposite hollow ends, and fasteners holding the frame legs or dowels in engaged attachment with said L-shaped corner members in unitary fixed assembly to rigidly hold the flexible gate member.

7. The child safety gate of claim 6 comprising a pair of transversely spaced zippers extending from an upper edge of the flexible gate member to the intermediate frame leg and secured to the flexible gate member, the zippers coacting with said flexible gate member when in a closed position serving to prevent ingress and egress through the flexible member and when in an open position allowing an intermediate gate section to drop to a lower level in close adjacency to the intermediate frame leg thus permitting ingress and egress through a gate opening created when the intermediate gate section has dropped.

8. The child safety gate of claim 1 wherein the pair of transversely spaced rigid upright frame legs and the intermediate leg comprise a one piece structure.

9. The child safety gate of claim 1 wherein the pair of transversely spaced rigid upright frame legs and the intermediate leg are separate from one another and have hinge means connecting opposite ends of the intermediate frame leg with lower ends of said transversely spaced rigid upright frame legs.

10. The child safety gate of claim 1 wherein the tubular L-shaped corner members are mounted on opposite ends of said intermediate frame leg and where said transversely spaced rigid upright frame legs are each mounted in telescoped connection with one of said tubular L-shaped corner members, and means physically attaching each of said tubular L-shaped corner members in locked connection with said intermediate frame leg and one of said transversely spaced rigid upright frame legs.

11. The child safety gate of claim 1 wherein the flexible gate member has a pair of transversely spaced upright zippers constructed and positioned so that when the zippers are moved from an upper closed position to a lower position an intermediate flexible gate section of said flexible member can be dropped to floor level to enable ingress and egress through the flexible gate member when desired.

12. The child safety gate of claim 1 wherein the flexible gate member has a pair of transversely spaced upright zippers so that the zippers when closed are in an upper position and further so that when the zippers are open the zippers terminate at a location spaced above said intermediate frame leg located at the bottom edge of said flexible gate member.

13. The child safety gate of claim 1 wherein the releasable fastener means for attaching the three sided rigid frame structure to stairway posts in assembled relation comprises hook and loop type fasteners and with the cushioned non-slip fabric layer being positioned at a location remote from the hook and loop fastener for direct engagement with stairway posts when in assembly with stairway posts.

14. The child safety gate of claim 1 wherein the flexible gate member is provided with a pair of vertically spaced slots on opposite sides of the flexible gate member and with the slots having a height slightly in excess of the height of said flexible strap-like adjustable hinges to enable closed intermediate sections of said flexible strap-like adjustable hinges to be lodged in said slots.

15. The child safety gate of claim 14 wherein said transversely spaced upright frame legs when assembled with said flexible gate member extend vertically through said slots securing said flexible strap-like adjustable hinges in unitary relation with said flexible gate member.

16. In a stairway structure with finely finished stairway posts at a bottom end of the stairway, the improvement of a child safety gate comprising:
a rigid gate frame structure including:
a pair of transversely spaced rigid upright frame legs and an intermediate frame leg positioned at right angles to said transversely spaced rigid upright frame legs;
a flexible gate member having means securing the gate member in unitary assembly with said rigid frame structure; and
pairs of flexible strap-like adjustable hinges with each pair secured to a different one of the transversely spaced rigid upright frame legs for securing the flexible adjustable foldable hinges to said spaced apart stairway posts, each of the flexible adjustable hinges being comprised of a flexible top strip piece having a cushioned non-slip fabric layer secured on an inside surface for confronting engagement with one of said stairway posts, each of the strip pieces and said cushioned non-slip fabric layer being sized, shaped and positioned for assembled contact with said upright stairway posts to prevent disfiguring, scratching and scarring of the exterior surfaces of the upright stairway posts when attached to the upright stairway posts, the flexible adjustable hinges each having releasable hook and loop fastener means for attaching the three sided rigid frame structure to said stairway posts in assembled relation.

17. The child safety gate of claim 16 wherein the flexible gate member is provided with a pair of vertically spaced slots on opposite sides of the flexible gate member and with the slots having a height slightly in excess of the height of said flexible strap-like adjustable hinges to enable closed intermediate sections of said flexible strap-like adjustable hinges to be lodged in said slots.

18. The child safety gate of claim 17 wherein said transversely spaced upright frame legs when assembled with said flexible gate member extend vertically through said slots securing said flexible strap-like adjustable hinges in unitary relation with said flexible gate member.

19. In a stairway structure with finely finished stairway posts at a bottom end of the stairway, the improvement of a child safety gate comprising:
a rigid gate frame structure including:
a pair of transversely spaced rigid upright frame legs and an intermediate frame leg positioned at right angles to said transversely spaced rigid upright frame legs;
a flexible gate member having means securing the gate member in unitary assembly with said rigid frame structure; and
pairs of flexible strap-like adjustable hinges with each pair secured to a different one of the transversely spaced rigid upright frame legs for securing the flexible adjustable foldable hinges to said spaced apart stairway posts, each of the flexible adjustable hinges being comprised of a flexible top strip piece having a cushioned non-slip fabric layer secured on an inside surface for confronting engagement with one of said stairway posts, each of the strip pieces and said cushioned non-slip fabric layer being sized, shaped and positioned for assembled contact with said upright stairway posts to prevent disfiguring, scratching and scarring of the exterior surfaces of the upright stairway posts when attached to the upright stairway posts.

20. The child safety gate of claim 19 wherein the intermediate frame leg comprises:
a connecting rod structure, the connecting rod structure having spring loaded finger-like pin members,
push buttons for releasing said finger-like pin members to move the spring loaded finger-like pin members from a storage position to an upright position; and
pin sockets at bottom ends of said transversely spaced rigid upright frame legs with said pin sockets being shaped and configured to receive said spring loaded finger-like pin members for securing the connecting rod structure to said transversely spaced rigid upright frame legs.
